(19) United States
(12) Patent Application Publication
(10) Pub. No.: US 2015/0103286 A1
(43) Pub. Date: Apr. 16, 2015

(54) DISPLAY DEVICE

(71) Applicant: Samsung Display Co., Ltd., Yongin-si (KR)

(72) Inventors: Joo Woan Cho, Seongnam-si (KR); Nak Cho Choi, Hwaseong-si (KR)

(73) Assignee: Samsung Display Co., Ltd., Yongin-si (KR)

(21) Appl. No.: 14/221,061

(22) Filed: Mar. 20, 2014

(30) Foreign Application Priority Data
Oct. 11, 2013 (KR) 10-2013-0121472

(51) Int. Cl. G02F 1/1333

(52) U.S. Cl. CPC G02F 1/133308
USPC 349/58

(57) ABSTRACT

A display device is disclosed. In one aspect, the display device includes a display panel displaying an image, a backlight assembly including a light source supplying light to the display panel, and a mold frame. The mold frame includes a quadrangular body surrounding the display panel and the backlight assembly, a support portion formed along an inner circumference of the body and supporting the display panel, and a plurality of buffer guides. The buffer guides are placed on the support portion the four corners of the mold frame. The buffer guide includes a bottom portion placed on the support portion and an impact absorbing portion formed over the bottom portion and contacting the body.

### CROSS-REFERENCE TO RELATED APPLICATIONS

This application claims priority to and the benefit of Korean Patent Application No. 10-2013-0121472 filed in the Korean Intellectual Property Office on Oct. 11, 2013, the entire contents of which are incorporated herein by reference.

### BACKGROUND

1. Field

The described technology generally relates to a display device.

2. Description of the Related Technology

Liquid crystal displays (LCDs) are one of the most common types of flat panel displays currently in use. LCDs include two panels each including a field generating electrode such as a pixel electrode or a common electrode and a liquid crystal layer interposed therebetween. LCDs generate an electric field in the liquid crystal layer by applying a voltage to the field generating electrodes that determines the orientation of liquid crystal molecules. The orientation of the liquid crystal molecules controls the polarization of incident light so as to display images.

The standard LCD display uses a display panel including a thin substrate to meet the demand for thin profile displays. The display panel can include a pixel electrode, a common electrode, and a liquid crystal layer formed together.

The display panel can be supported by a mold frame. As the thickness of display panel decreases, the display panel is more easily damaged due to external impact such as experienced during falling.

### SUMMARY OF CERTAIN INVENTIVE ASPECTS

One inventive aspect is a display device that can prevent a display panel from being damaged due to external impact.

Another aspect is a display device including a display panel displaying an image, a backlight assembly disposed below the display panel and including a light source supplying light to the display panel, and a mold frame supporting the display panel and surrounding the backlight assembly, in which the mold frame includes a quadrangular body of which an upper surface and a lower surface are opened, a support portion disposed along a circumference of the body and supporting the display panel, and a plurality of buffer guides, the buffer guides are disposed on the support portion at four corners of the mold frame, and the buffer guide includes a bottom portion disposed on the support portion and an impact absorbing portion disposed on the bottom portion and contacting an inner side of the body.

The buffer guide may be made of a soft material.

A lower portion of the display panel may contact the bottom portion and the side of the display panel may contact the impact absorbing portion.

A dent portion may be formed at the support portion at the four corners of the mold frame.

The bottom portion may be disposed in the dent portion.

The height of the upper surface of the bottom portion may be the same as the height of the upper surface of the support portion.

The bottom portion may have an L-shape in which a first surface and a second surface are connected to each other.

The impact absorbing portions may be disposed on the first surface and the second surface of the bottom portion.

The buffer guide may include a plurality of grooves formed in the impact absorbing portion.

The grooves may contact the inner side of the body.

The buffer guide may include a plurality of openings formed in the impact absorbing portion and exposing the bottom portion.

The impact absorbing portion may include a first portion contacting the bottom portion and a second portion extending toward the inside of the mold frame from an upper portion of first portion.

The side of the display panel may contact the first portion of the impact absorbing portion and the upper portion of the display panel may contact the second portion of the impact absorbing portion.

The buffer guide may include a plurality of grooves formed in the first portion of the impact absorbing portion.

The buffer guide may include a plurality of openings formed in the first portion of the impact absorbing portion and exposing the bottom portion.

The buffer guide may be further disposed between the four corners of the mold frame.

According to at least one embodiment, it is possible to prevent a display panel from being damaged due to external impact by placing a buffer guide made of a soft material at four corners of a mold frame.

### BRIEF DESCRIPTION OF THE DRAWINGS

FIG. 1 is an exploded perspective view of a display device according to an exemplary embodiment.

FIG. 2 is an assembled perspective view of the display device of FIG. 1.

FIG. 3 is a cross-sectional view taken along line III-III of FIG. 2.

FIG. 4 is a diagram illustrating a mold frame according to an exemplary embodiment.

FIG. 5 is a diagram illustrating a buffer guide according to an exemplary embodiment.

FIG. 6 is a cross-sectional view taken along line VI-VI of FIG. 4.

FIG. 7 is a diagram illustrating the supporting of the display panel by the mold frame according to an exemplary embodiment.

FIG. 8 is a diagram illustrating a buffer guide according to another exemplary embodiment.

FIG. 9 is a diagram illustrating a buffer guide according to yet another exemplary embodiment.

FIG. 10 is a diagram illustrating a buffer guide according to yet another exemplary embodiment.

FIG. 11 is a diagram illustrating the supporting of the display panel by the mold frame including the buffer guide of FIG. 10.

FIG. 12 is a diagram illustrating a buffer guide according to still yet another exemplary embodiment.

FIG. 13 is a diagram illustrating a buffer guide according to another exemplary embodiment.

FIG. 14 is a diagram illustrating a mold frame according to another exemplary embodiment.

### DETAILED DESCRIPTION OF CERTAIN INVENTIVE EMBODIMENTS

Hereinafter, exemplary embodiments of the described technology will be described in detail with reference to the accompanying drawings. As those skilled in the art would realize, the described embodiments may be modified in various different ways, all without departing from the spirit or scope of the described technology. On the contrary, exemplary embodiments introduced herein are provided to make the disclosed contents thorough and complete and sufficiently convey the spirit of the described technology to those skilled in the art.

In the drawings, the thicknesses of layers, films, panels, regions, etc., may be exaggerated for clarity. It will be understood that when a layer is referred to as being “on” another layer or substrate, it can be directly on the other layer or substrate, or intervening elements may also be present. Like reference numerals designate like elements throughout the specification.

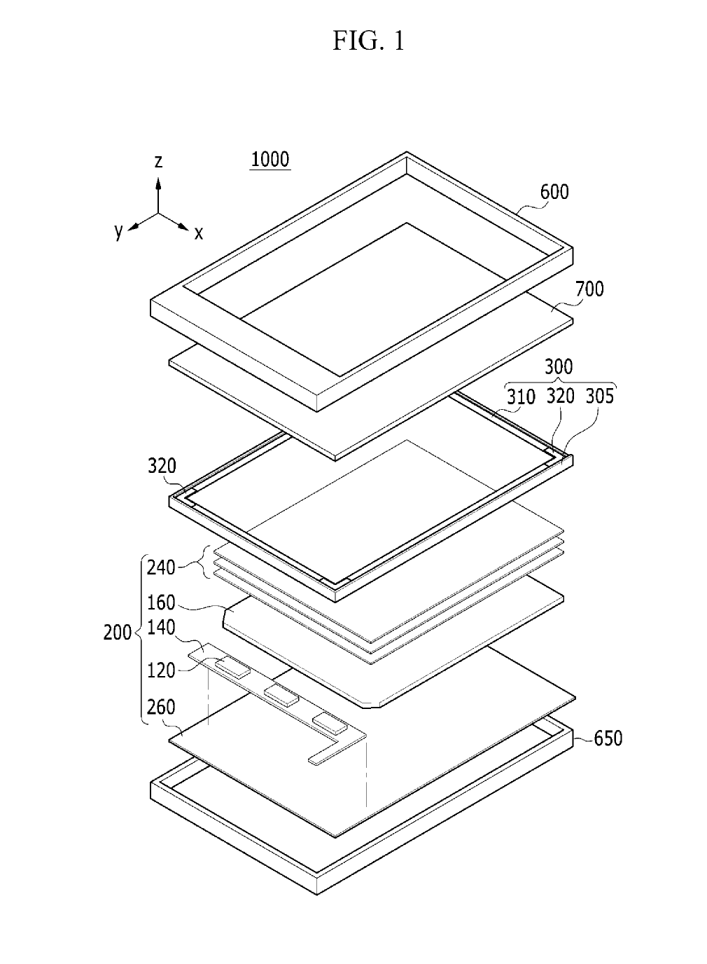

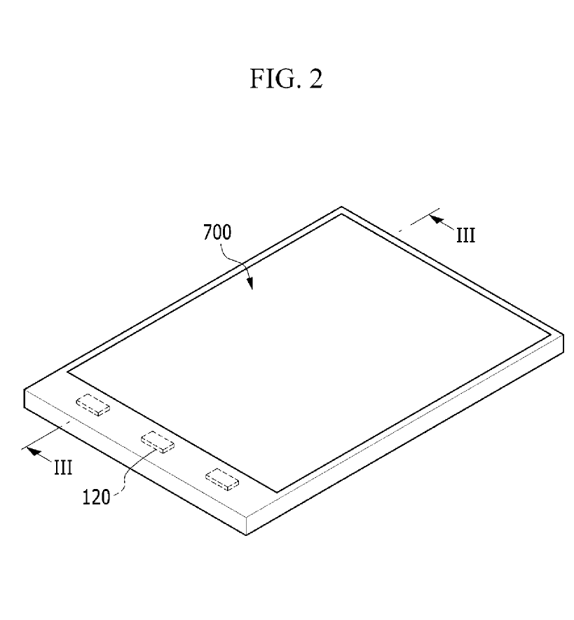

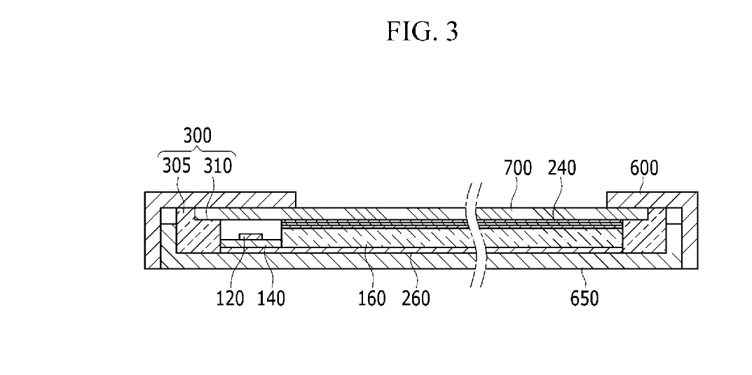

FIG. 1 is an exploded perspective view of a display device according to an exemplary embodiment. FIG. 2 is an assembled perspective view of the display device of FIG. 1. FIG. 3 is a cross-sectional view taken along line III-III of FIG. 2.

Referring to FIGS. 1 to 3, a display device 1000 includes a backlight assembly 200 for supplying light and a display panel 700 receiving the light to display an image.

Further, the display device 1000 includes a mold frame 300, a top chassis 600, and a bottom chassis 650 for fixing and supporting the backlight assembly 200 and the display panel 700.

Further, the display device 1000 may include a protection window for protecting the display panel 700 from impact and preventing foreign particles from penetrating into the display device from the environment.

The display device 1000 may further include a touch panel on which a text or a figure is written or drawn by contacting a finger or a touch pen (stylus) on a screen, or a desired command is executed by operating an icon.

In some embodiments, the display panel 700 is a liquid crystal panel including one thin substrate having a quadrangular shape and formed of an insulating material such as transparent glass, plastic, or the like. A plurality of thin film layers such as thin film transistors, pixel electrodes, common electrodes, color filters, and liquid crystal layers are formed together as part of the liquid crystal panel. The liquid crystal layer may be located in a micro-cavity formed between the pixel electrode and the common electrode. The pixel electrode is connected to the thin film transistor and receives a data voltage therefrom and the common electrode receives a common voltage.

According to some embodiments, the display panel 700 is a liquid crystal panel including two thin substrates having quadrangular shapes, facing each other, and formed of insulating materials such as glass, plastic, or the like. A liquid crystal layer is formed between the two substrates. A plurality of thin film layers such as thin film transistors, data lines, gate lines, and pixel electrodes are formed on one substrate. The data line is connected to a source terminal of the thin film transistor, the gate line is connected to a gate terminal of the thin film transistor, and a pixel electrode is connected to a drain terminal of the thin film transistor. Thin film layers such as common electrodes and color filters for filtering while light passing through the color filters such that predetermined colors are displayed are formed on the other substrate.

The backlight assembly 200 for supplying substantially uniform light to the display panel 700 is formed below the display panel 700.

The backlight assembly 200 includes one or more light sources 120 fixed to the mold frame 300 and the bottom chassis 650 and supplying the light to the display panel 700. The backlight assembly also includes a light source substrate 140 supplying power to the light sources 120. Here, the light source 120 may be a light-emitting diode (LED).

The backlight assembly 200 also includes a light guide 160 guiding light emitted from the light source 120 to supply the light to the display panel 700, a reflective sheet 260 formed below the light guide 160 and reflecting the light, and optical sheets 240 formed on the light guide 160 to improve the luminance characteristics of the light from the light source 120 to supply the light to the display panel 700.

The mold frame 300 has a quadrangular shape and forms openings on upper and lower sides thereof. The mold frame 300 also surrounds the backlight assembly 200. Further, the mold frame 300 supports the display panel 700.

The mold frame 300 includes a body 305 having a quadrangular shape with open upper and lower surfaces, a support portion 310 supporting the display panel 700, and a plurality of buffer guides 320.

The support portion 310 is formed along the circumference of the body 305 and the buffer guides 320 are positioned at four corners of the mold frame 300 and formed on the support portion 310 of the mold frame 300. A portion of the edge of the display panel 700 is supported by the support portion 310 and the buffer guides 320 of the mold frame 300. The buffer guide 320 protects the display panel 700 from external impact such as falling.

The bottom chassis 650 seats and supports the backlight assembly 200 and the mold frame 300.

The top chassis 600 protects and supports the display panel 700 and is formed on the display panel 700. The top chassis 600 prevents the display panel 700, the backlight assembly 200, and the mold frame 300 from being removed from the bottom chassis 650.

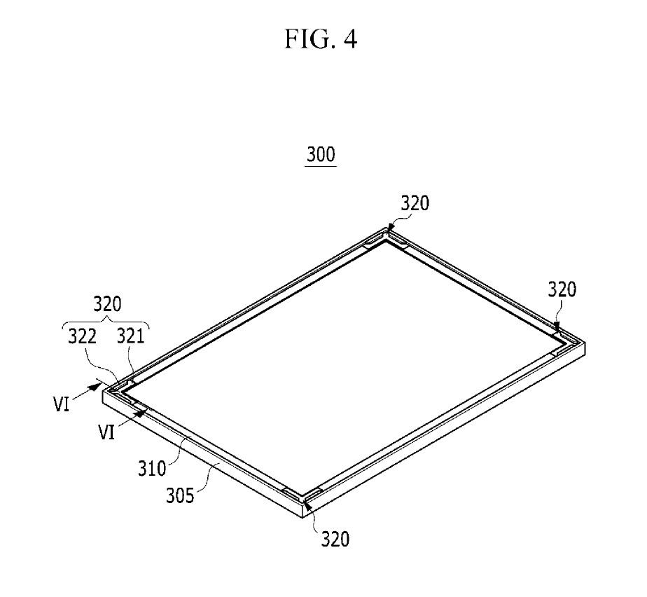

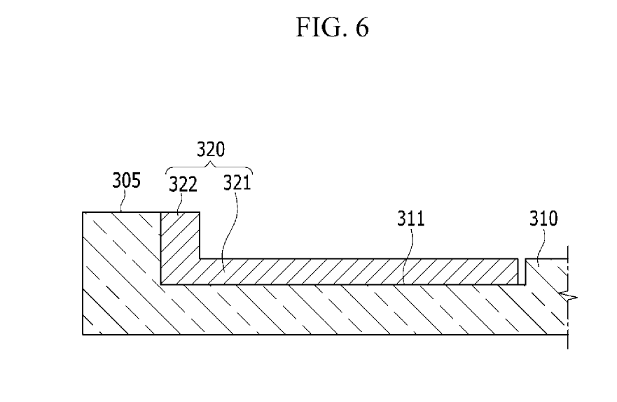

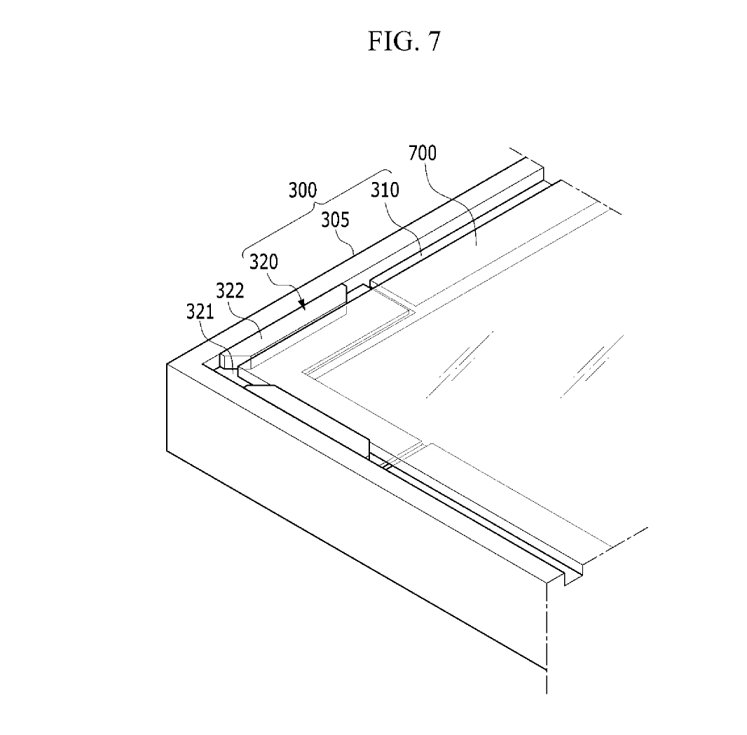

Next, the mold frame according to an exemplary embodiment will be described in detail with reference to FIGS. 4 to 7.

Referring to FIGS. 4 to 7, the mold frame 300 includes a body 305 having a quadrangular shape with open upper and lower surfaces, a support portion 310 supporting the display panel 700, and a plurality of buffer guides 320.

The support portion 310 is formed along the inner circumference of the quadrangular body 305. The buffer guides 320 are formed on the support portion 310 at four corners of the mold frame 300.

The buffer guide 320 is formed of a soft material such as silicon rubber or urethane to protect the display panel 700 from external impact such as falling.

The buffer guide 320 includes a bottom portion 321 and an impact absorbing portion 322 formed on the bottom portion 321. The bottom portion 321 has an L-shape in which a first surface and a second surface are connected. The bottom portion 321 is formed at two sides which meet at a corner of the mold frame 300 and the impact absorbing portions 322 are respectively formed on the first and second surfaces of the bottom portion 321. The impact absorbing portions 322 formed on the first and second surfaces are not connected to each other. However, the described technology is not limited thereto, and the impact absorbing portions 322 may be connected to each other in some embodiments.

A dent portion or a recess 311 is formed at the four corners of the mold frame 300. The bottom portion 321 of the buffer guide 320 is formed in the dent portion 311 and the impact absorbing portions 322 of the buffer guide 320 contacts an inner side of the body 305 of the mold frame 300. Since the bottom portion 321 of the buffer guide 320 is formed in the dent portion 311, a step is not formed between the bottom portion 321 of the buffer guide 320 and the support portion 310. That is, the height of the upper surface of the bottom portion 321 of the buffer guide 320 is substantially the same as the height of the upper surface of the support portion 310 of the mold frame 300.

As such, since the bottom portion 321 of the buffer guide 320 is formed in the dent portion 311 and thus a step is not formed between the bottom portion 321 of the buffer guide 320 and the support portion 310, defects caused by such a step may be prevented when supporting the display panel 700.

The mold frame 300 supports the display panel 700 and the edge of the display panel 700 is seated in the support portion 310 of the mold frame 300. In addition, the edge of the display panel 700 is seated in the bottom portion 321 of the buffer guide 320 at the four corners of the mold frame 300. That is, the lower portion of the display panel 700 contacts the bottom portion 321 of the buffer guide 320.

Further, the side of the display panel 700 contacts the impact absorbing portions 322 of the buffer guide 320 at the four corners of the mold frame 300. Accordingly, when applying an external impact such as during falling, the impact absorbing portions 322 of the buffer guide 320 absorbs the impact to prevent the display panel 700 from being damaged.

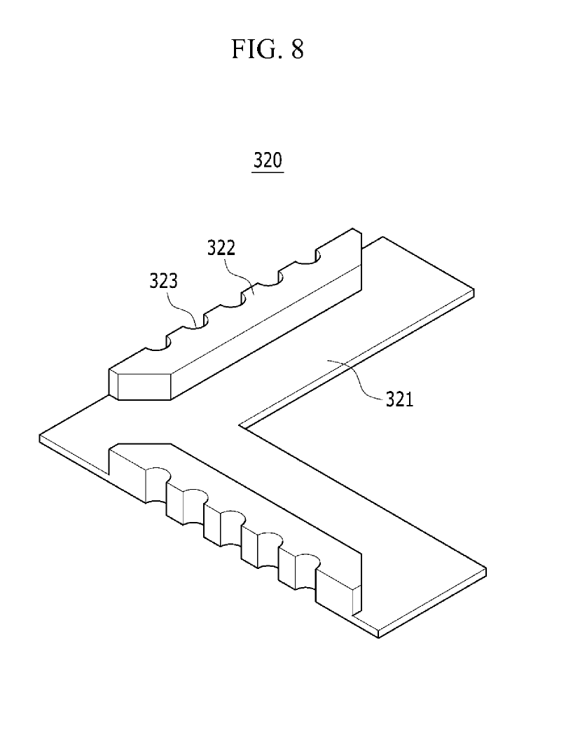

Additionally, the buffer guide 320 may have various shapes. A number of the shapes of the buffer guide 320 will be described with reference to FIGS. 8 to 13.

Referring to FIG. 8, the buffer guide 320 includes a bottom portion 321 and an impact absorbing portion 322 formed on the bottom portion 321.

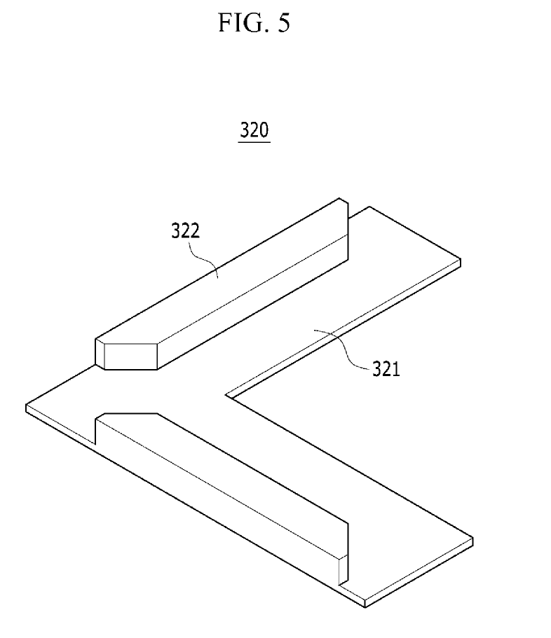

The material of the buffer guide 320 and the shape of the bottom portion 321 are the same as those of the buffer guide 320 shown in FIG. 5. Accordingly, a description of the bottom portion 321 is omitted.

The impact absorbing portions 322 are respectively formed on a first surface and a second surface of the bottom portion 321. The impact absorbing portions 322 formed on the first and second surfaces of the bottom portion 321 are not connected to each other. However, the described technology is not limited thereto, and the impact absorbing portions 322 formed on the first and second surfaces of the bottom portion 321 may be connected to each other in some embodiments.

A plurality of grooves 323 are formed in the impact absorbing portions 322. The grooves 323 are formed at a position where the impact absorbing portions 322 contacts the inner side of the body 305 of the mold frame 300. That is, the grooves 323 contact the inner side of the body 305 of the mold frame 300. Accordingly, a layer of air is formed between the grooves 323 and the inner side of the body 305 of the mold frame 300.

When applying an external impact such as during falling, the impact absorbing portions 322 of the buffer guide 320 absorbs the impact to prevent the display panel 700 from being damaged. Further, since the grooves 323 are formed in the impact absorbing portions 322, even when the intensity of external impact increases, the layer of air between the grooves 323 and the inner side of the body 305 of the mold frame 300 may absorb the impact.

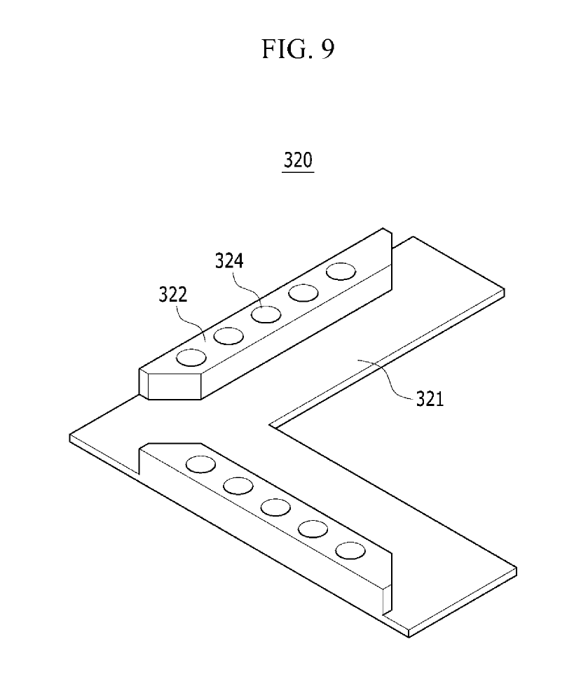

Referring to the embodiment shown in FIG. 9, the buffer guide 320 includes a bottom portion 321 and an impact absorbing portion 322 formed on the bottom portion 321.

The material of the buffer guide 320 and the shape of the bottom portion 321 are the same as those of the buffer guide 320 shown in FIG. 5. Accordingly, a description of the bottom portion 321 is omitted.

The impact absorbing portions 322 are respectively formed on a first surface and a second surface of the bottom portion 321. The impact absorbing portions 322 formed on the first and second surfaces of the bottom portion 321 are not connected to each other. However, the described technology is not limited thereto, and the impact absorbing portions 322 formed on the first and second surfaces of the bottom portion 321 may be connected to each other in some embodiments.

A plurality of openings 324 are formed in the impact absorbing portions 322 exposing the bottom portion 321. A layer of air is formed in the openings 324. According to other embodiments, the openings 324 are formed in the impact absorbing portions 322 and the bottom portion 321.

When applying an external impact such as during falling, the impact absorbing portions 322 of the buffer guide 320 absorb the impact to prevent the display panel 700 from being damaged. Further, since the openings 324 are formed in the impact absorbing portions 322, when the intensity of external impact increases, the layer of air in the openings 324 may absorb the impact.

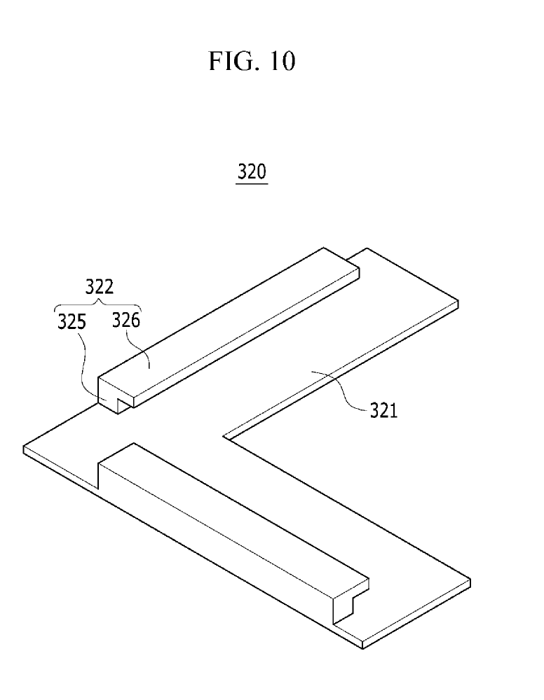

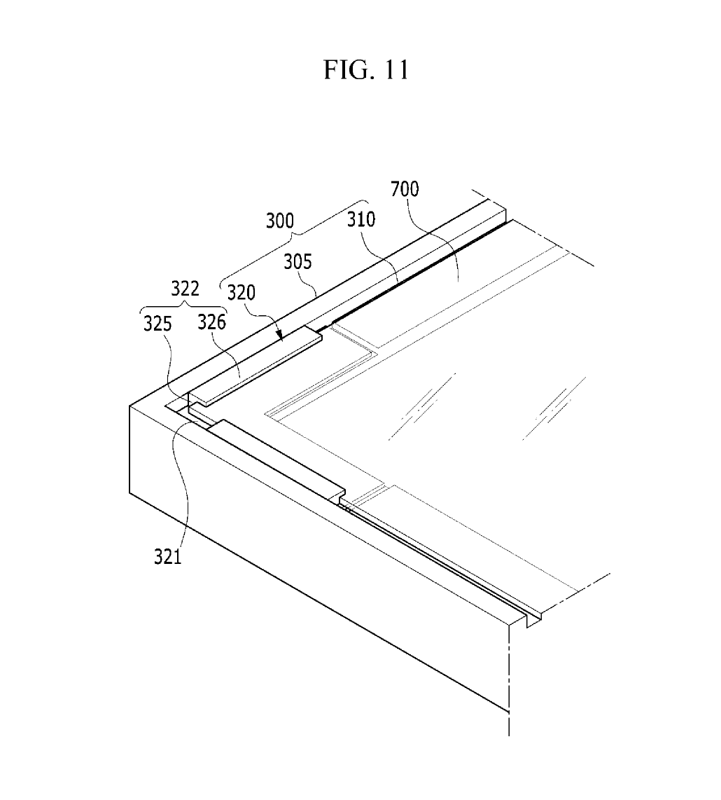

FIG. 10 is a diagram illustrating a buffer guide according to yet another exemplary embodiment and FIG. 11 is a diagram illustrating the supporting of the display panel by the mold frame shown in FIG. 10.

Referring to FIGS. 10 and 11, the buffer guide 320 includes a bottom portion 321 and an impact absorbing portion 322 formed on the bottom portion 321.

The material of the buffer guide 320 and the shape of the bottom portion 321 are the same as those of the buffer guide 320 shown in FIG. 5. Accordingly, detailed description of the bottom portion 321 is omitted.

The impact absorbing portions 322 are respectively formed on a first surface and a second surface of the bottom portion 321. The impact absorbing portions 322 formed on the first and second surfaces of the bottom portion 321 are not connected to each other. However, the described technology is not limited thereto and the impact absorbing portions 322 may be connected to each other.

The impact absorbing portions 322 include a first portion 325 which contacts the bottom portion 321 and the inner side of the body 305 of the mold frame 300. The impact absorbing portions 322 also include a second portion 326 extending from the upper surface of the first portion 325. According to some embodiments, the second portion 326 of the impact absorbing portions 322 extends toward the inside of the mold frame 300 and is substantially parallel to the bottom portion 321.

When the display panel 700 is seated, the lower portion of the display panel 700 contacts the bottom portion 321, the side of the display panel 700 contacts the first portion 325 of the impact absorbing portions 322, and the upper portion of the display panel 700 contacts the first portion 325 of the impact absorbing portions 322.

Accordingly, when applying an external impact such as during falling, the first portion 325 of the impact absorbing portions 322 absorbs the impact to prevent the display panel 700 from being damaged and the second portion 326 of the impact absorbing portions 322 prevents the display panel 700 from being separated from the mold frame 300.

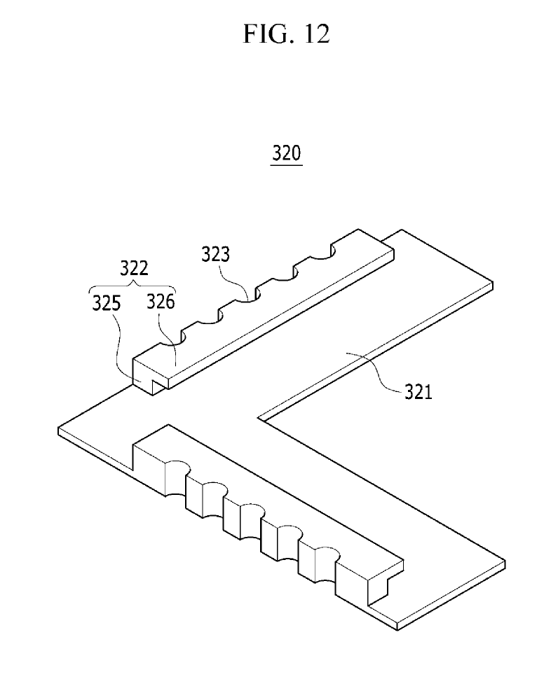

FIG. 12 is a diagram illustrating a buffer guide according to yet another exemplary embodiment.

Referring to FIG. 12, the buffer guide 320 includes a bottom portion 321 and an impact absorbing portion 322 formed on the bottom portion 321.

The material of the buffer guide 320 and the shape of the bottom portion 321 are the same as those of the buffer guide 320 shown in FIG. 5. Accordingly, a description of the bottom portion 321 is omitted.

The impact absorbing portions 322 are respectively formed on a first surface and a second surface of the bottom portion 321. The impact absorbing portions 322 formed on the first and second surfaces of the bottom portion 321 are not connected to each other. However, the described technology is not limited thereto, and the impact absorbing portions 322 may be connected to each other.

The impact absorbing portions 322 include a first portion 325 which contacts the bottom portion 321 and the inner side of the body 305 of the mold frame 300. The impact absorbing portions 322 also include a second portion 326 extending from the upper surface of the first portion 325. The second portion 326 of the impact absorbing portions 322 extends toward the inside of the mold frame 300 and is substantially parallel to the bottom portion 321.

A plurality of grooves 323 are formed in the first portion 325 of the impact absorbing portions 322. The grooves 323 are formed in a position where the impact absorbing portions 322 contacts the inner side of the body 305 of the mold frame 300. That is, the grooves 323 contact the inner side of the body 305 of the mold frame 300. Accordingly, a layer or air is formed between the grooves 323 and the inner side of the body 305 of the mold frame 300.

When the display panel 700 is seated, the lower portion of the display panel 700 contacts the bottom portion 321, the side of the display panel 700 contacts the first portion 325 of the impact absorbing portions 322, and the upper portion of the display panel 700 contacts the first portion 325 of the impact absorbing portions 322. Accordingly, when applying an external impact such as during falling, the first portion 325 of the impact absorbing portions 322 absorbs the impact to prevent the display panel 700 from being damaged and the second portion 326 of the impact absorbing portions 322 prevents the display panel 700 from being separated from the mold frame 300.

Further, since the grooves 323 are formed in the first portion 325 of the impact absorbing portions 322, when the intensity of external impact increases, the layer or air between the grooves 323 and the inner side of the body 305 of the mold frame 300 absorb the impact.

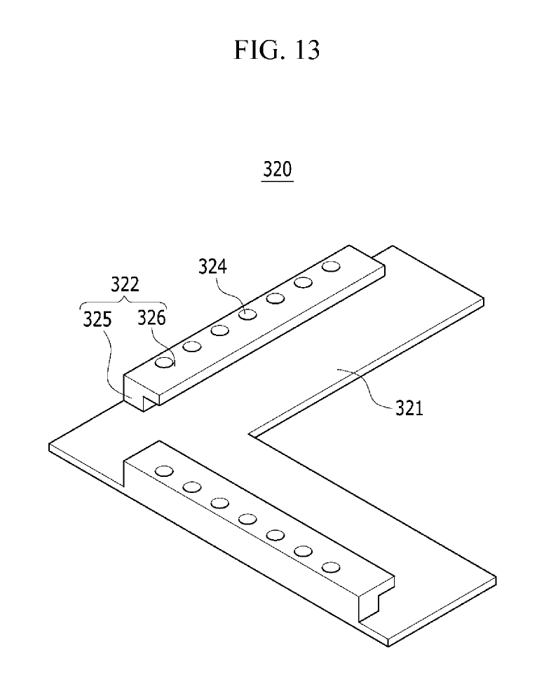

FIG. 13 is a diagram illustrating a buffer guide according to yet another exemplary embodiment.

Referring to FIG. 13, the buffer guide 320 includes a bottom portion 321 and an impact absorbing portion 322 formed on the bottom portion 321.

The material of the buffer guide 320 and the shape of the bottom portion 321 are the same as those of the buffer guide 320 shown in FIG. 5. Accordingly, a description of the bottom portion 321 is omitted.

The impact absorbing portions 322 are respectively formed on a first surface and a second surface of the bottom portion 321. The impact absorbing portions 322 formed on the first and second surfaces of the bottom portion 321 are not connected to each other. However, the described technology is not limited thereto, and the impact absorbing portions 322 may be connected to each other.

The impact absorbing portions 322 include a first portion 325 which contacts the bottom portion 321 and the inner side of the body 305 of the mold frame 300. The impact absorbing portions 322 also include a second portion 326 extending from the upper surface of the first portion 325. The second portion 326 of the impact absorbing portions 322 extends toward the inside of the mold frame 300 and is substantially parallel to the bottom portion 321.

A plurality of openings 324 exposing the bottom portion 321 are formed in the first portion 325 of the impact absorbing portions 322.

When the display panel 700 is seated, the lower portion of the display panel 700 contacts the bottom portion 321, the side of the display panel 700 contacts the first portion 325 of the impact absorbing portions 322, and the upper portion of the display panel 700 contacts the first portion 325 of the impact absorbing portions 322. Accordingly, when applying an external impact such as during falling, the first portion 325 of the impact absorbing portions 322 absorbs the impact to prevent the display panel 700 from being damaged and the second portion 326 of the impact absorbing portions 322 prevents the display panel 700 from being separated from the mold frame 300.

Further, since the openings 324 are formed in the first portion 325 of the impact absorbing portions 322, when the intensity of external impact increases, the layer or air in the openings 324 may absorb the impact.

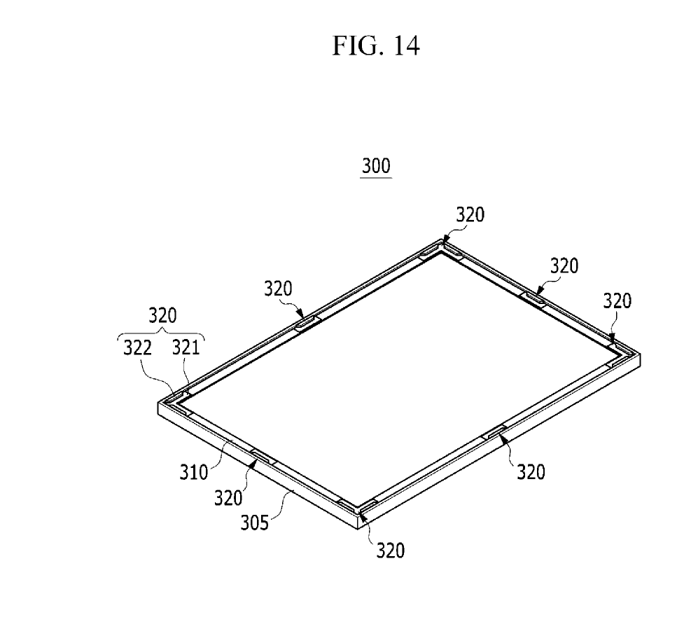

Additionally, the buffer guide 320 may be formed in other positions in addition to the four corners of the mold frame 300. A mold frame according to another exemplary embodiment will be described with reference to FIG. 14.

Referring to FIG. 14, the mold frame 300 includes a body 305 having a quadrangular shape with open upper and lower surfaces, a support portion 310 supporting the display panel 700, and a plurality of buffer guides 320.

The support portion 310 is formed along the circumference of the quadrangular body 305. The buffer guides 320 are formed on four corners of the mold frame 300 and on the support portion 310 between the four corners of the mold frame 300.

The buffer guides 320 positioned at the four corners of the mold frame 300 may be the buffer guides 320 described above in any of FIG. 5, 8, 9, 10, 12, or 13.

The buffer guides 320 formed between the four corners of the mold frame 300 only differ from the buffer guides 320 described above in the shape of the bottom portions 321. Otherwise, the buffer guides 320 formed between the four corners are the same as those shown in FIG. 5, 8, 9, 10, 12, or 13. In some embodiments, the shape of the bottom portion 321 of the buffer guides 320 formed between the four corners of the mold frame 300 is rectangular.

While this described technology has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A display device, comprising:
a display panel configured to display an image;
a backlight assembly including a light source configured to supply light to the display panel; and
a mold frame including i) a quadrangular body surrounding the display panel and the backlight assembly, ii) a support portion formed along an inner circumference of the body and supporting the display panel, and iii) a plurality of buffer guides,
wherein the buffer guides are placed on the support portion at the corners of the mold frame, and
wherein each of the buffer guides includes i) a bottom portion placed on the support portion and ii) an impact absorbing portion formed over the bottom portion and contacting the body.

2. The display device of claim 1, wherein each of the buffer guides is formed of a soft material.

3. The display device of claim 2, wherein a lower portion of the display panel contacts each of the bottom portions wherein aside of the display panel contacts the impact absorbing portions, and wherein the side of the display panel is substantially perpendicular to the lower portion of the display panel.

4. The display device of claim 3, wherein the mold frame further includes recesses formed in the support portion at the corners of the mold frame.

5. The display device of claim 4, wherein the bottom portions are respectively placed in the recesses.

6. The display device of claim 5, wherein the height of each of the bottom portions is substantially the same as the depth of the respective recess.

7. The display device of claim 1, wherein each of the bottom portions includes first and second surfaces connected to each other to form a substantially L-shape.

8. The display device of claim 7, wherein the impact absorbing portion includes a pair of impact absorbing portions respectively formed on the first and second surfaces of the bottom portion.

9. The display device of claim 8, wherein each of the buffer guides has a plurality of grooves formed in each of the impact absorbing portions.

10. The display device of claim 9, wherein the grooves contact an inner side of the body.

11. The display device of claim 8, wherein each of the buffer guides has a plurality of openings formed in each of the impact absorbing portions and wherein the openings of each buffer guide exposes the respective bottom portion.

12. The display device of claim 8, wherein each of the impact absorbing portions includes i) a first portion contacting the bottom portion and ii) a second portion formed over the first portion and extending toward an interior of the mold frame.

13. The display device of claim 12, wherein a side of the display panel contacts the first portion of each of the impact absorbing portions wherein the upper portion of the display panel contacts the second portion of each of the impact absorbing portions, and wherein the side of the display panel is substantially perpendicular to the lower portion of the display panel.

14. The display device of claim 13, wherein each of the buffer guides has a plurality of grooves formed in the first portion of each of the impact absorbing portions.

15. The display device of claim 14, wherein each of the grooves contacts an inner side of the body.

16. The display device of claim 13, wherein each of the buffer guides has a plurality of openings formed in the first portion of each of the impact absorbing portions and wherein the openings of each buffer guide exposes the respective bottom portion.

17. The display device of claim 1, further including additional buffer guides placed between the corners of the mold frame.

18. A display device, comprising:
a display panel configured to display an image;
a mold frame supporting the display panel; and
a plurality of elastic members interposed between the display panel and the mold frame and configured to at least partially absorb an impact applied to the display panel.

19. The display device of claim 18, wherein the mold frame has a substantially quadrangular shape and wherein the elastic members comprise four sub-elastic members separated from each other and formed at the four corners of the mold frame.

20. The display device of claim 18, wherein a plurality of openings are formed in each of the elastic members.
